(19) United States
(12) Patent Application Publication
(10) Pub. No.: US 2024/0394381 A1
(43) Pub. Date: Nov. 28, 2024

(54) BACKDOOR DETECTION DEVICE, BACKDOOR DETECTION METHOD, AND RECORDING MEDIUM

(71) Applicant: NEC Corporation, Minato-ku, Tokyo (JP)

(72) Inventor: Kohei TATARA, Tokyo (JP)

(73) Assignee: NEC Corporation, Minato-ku, Tokyo (JP)

(21) Appl. No.: 18/693,987

(22) PCT Filed: Oct. 27, 2021
(86) PCT No.: PCT/JP2021/039604

§ 371 Date: Mar. 21, 2024

(51) Int. Cl. G06F 21/57

(52) U.S. Cl. CPC G06F 21/577

(57) ABSTRACT

A backdoor detection device according to the present disclosure is equipped with: a pattern extraction means that extracts a function flow pattern from the program code of firmware; a frequency information acquisition means that acquires appearance frequency information indicating the appearance frequency of the extracted function flow pattern; a determination means that determines whether a backdoor is included on the basis of the acquired appearance frequency information; and an output means that outputs information indicating the result of the determination by the determination means.

### TECHNICAL FIELD

The present disclosure relates to a backdoor detection device, a backdoor detection method, and a recording medium.

### BACKGROUND ART

As one countermeasure against supply chain and risks when a device is procured from the outside, there is a technology for detecting an unauthorized function in firmware, such as a backdoor.

For example, PTL 1 discloses a backdoor detection device that analyzes a propagation state of confidential data in software and specifies a source code estimated to be a backdoor.

### CITATION LIST

### Patent Literature

PTL 1: WO 2021/028989 A1

### SUMMARY OF INVENTION

### Technical Problem

However, in an unauthorized access using a backdoor, a function flow that significantly affects the system is executed with information known only by an attacker as a trigger in many cases. Even if the software is analyzed with the invention disclosed in PTL 1 described above, it is difficult to determine which part includes the backdoor.

An example of an object of the present disclosure is to provide a backdoor detection device capable of detecting a backdoor without complicated analysis.

### Solution to Problem

A backdoor detection device in an aspect of the present disclosure includes pattern extraction means that extracts a function flow pattern from program codes of firmware, frequency information acquisition means that acquires appearance frequency information indicating an appearance frequency of the extracted function flow pattern, backdoor determination means that determines whether a backdoor is included based on the acquired appearance frequency information, and output means that outputs information indicating a result of the determination by the backdoor determination means.

A backdoor detection method in another aspect of the present disclosure includes extracting a function flow pattern from program codes of firmware, acquiring appearance frequency information indicating an appearance frequency of the extracted function flow pattern, determining whether a backdoor is included based on the acquired appearance frequency information, and outputting information indicating a result of the determination.

A recording medium in still another aspect of the present disclosure stores a program for causing a computer to perform extracting a function flow pattern from program codes of firmware, acquiring appearance frequency information indicating an appearance frequency of the extracted function flow pattern, determining whether a backdoor is included based on the acquired appearance frequency information, and outputting information indicating a result of the determination.

### Advantageous Effects of Invention

As an example of an effect according to the present disclosure, it is possible to provide a backdoor detection device capable of detecting a backdoor without complicated analysis.

### BRIEF DESCRIPTION OF DRAWINGS

FIG. 1 is a block diagram illustrating a configuration of a backdoor detection device in a first example embodiment.

FIG. 2 is a diagram illustrating a hardware configuration in which the backdoor detection device in the first example embodiment is achieved by a computer device and peripheral devices of the computer device.

FIG. 3 is a diagram for describing a control flow in the first example embodiment.

FIG. 4 is a diagram for describing a function flow pattern in the first example embodiment.

FIG. 5 is a table for describing appearance frequency information in the first example embodiment.

FIG. 6 is a flowchart illustrating an operation of backdoor detection in the first example embodiment.

FIG. 7 is a table for describing appearance frequency information in a modification example of the first example embodiment.

FIG. 8 is a flowchart illustrating an operation of backdoor detection in the modification example of the first example embodiment.

FIG. 9 is a block diagram illustrating a configuration of a backdoor detection device in a second example embodiment.

FIG. 10 is a diagram for describing a function flow specified in the second example embodiment.

FIG. 11 is a flowchart illustrating an operation of backdoor detection in the second example embodiment.

### EXAMPLE EMBODIMENT

Hereinafter, example embodiments will be described in detail with reference to the drawings.

### First Example Embodiment

A backdoor detection device 100 in a first example embodiment is a device that detects whether an unauthorized function such as a backdoor is included in firmware of a provided device when the device provided from an external business operator is incorporated in the own system, for example. In the backdoor detection device 100, for example, information of a function that depends on an external input is stored in a storage device 505 in advance. The firmware that is a detection target may be source codes before compilation or binary codes after compilation. The following description will be mainly made on the assumption that input firmware is binary codes.

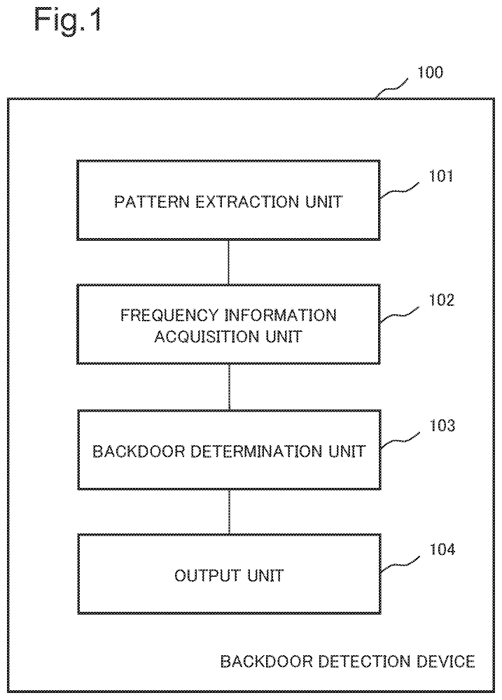

FIG. 1 is a block diagram illustrating a configuration of the backdoor detection device 100 in the first example embodiment. Referring to FIG. 1, the backdoor detection device 100 includes a pattern extraction unit 101, a frequency information acquisition unit 102, a backdoor determination unit 103, and an output unit 104. The backdoor detection device 100 which is an essential configuration of the present example embodiment will be described below in detail.

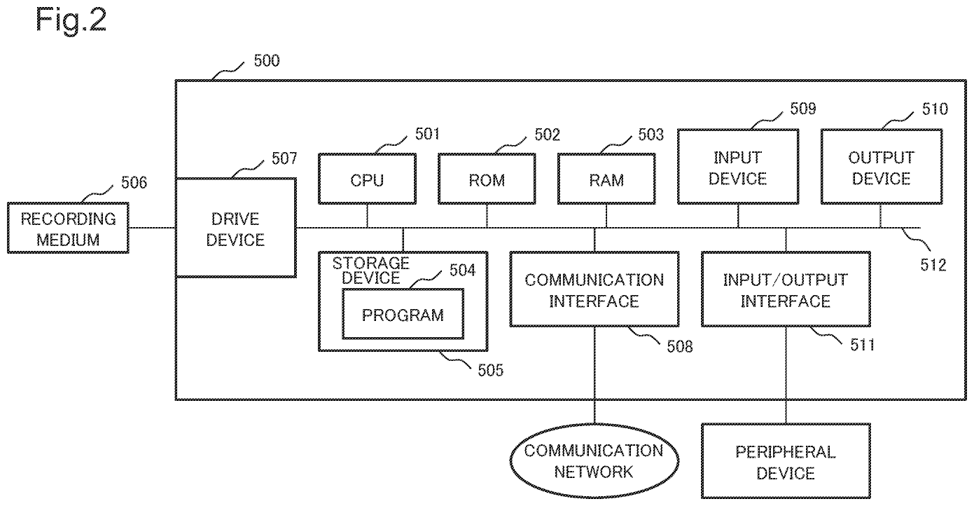

FIG. 2 is a diagram illustrating an example of a hardware configuration in which the backdoor detection device 100 in the first example embodiment of the present disclosure is achieved by a computer device 500 including a processor. As illustrated in FIG. 2, the backdoor detection device 100 includes a central processing unit (CPU) 501, a memory such as a read only memory (ROM) 502 and a random access memory (RAM) 503, a storage device 505 such as a hard disk that stores a program 504, a communication interface (I/F) 508 for network connection, and an input/output interface 511 that inputs and outputs data. In the first example embodiment, program codes of firmware acquired by the pattern extraction unit 101 are input to the backdoor detection device 100 via the input/output interface 511.

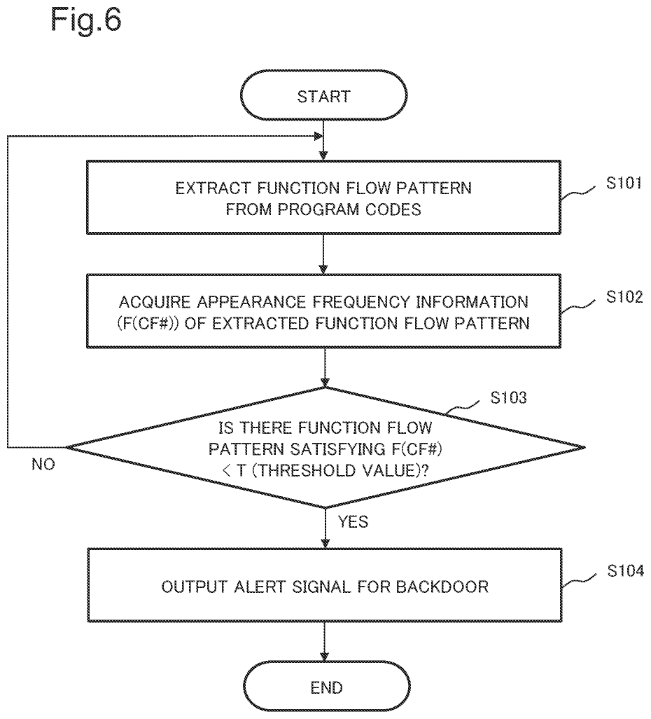

The CPU 501 controls the entirety of the backdoor detection device 100 according to the first example embodiment of the present invention by operating an operating system. The CPU 501 reads a program and data from a recording medium 506 mounted on, for example, a drive device 507 to the memory. The CPU 501 functions as the pattern extraction unit 101, the frequency information acquisition unit 102, the backdoor determination unit 103, the output unit 104, and parts of the above units in the first example embodiment, and executes processes or commands in the flowchart illustrated in FIG. 6 to be described later based on the program.

The recording medium 506 is, for example, an optical disc, a flexible disk, a magnetic optical disc, an external hard disk, a semiconductor memory, or the like. Some recording media of the storage device are non-volatile storage devices, and record programs therein. The program may be downloaded from an external computer (not illustrated) connected to a communication network.

The input device 509 is achieved by, for example, a mouse, a keyboard, a built-in key button, and the like, and is used for an input operation. The input device 509 is not limited to the mouse, the keyboard, and the built-in key button, and may be, for example, a touch panel. The output device 510 is achieved by, for example, a display, and is used to confirm an output.

As described above, the first example embodiment illustrated in FIG. 1 is achieved by computer hardware illustrated in FIG. 2. Means for achieving each unit provided in the backdoor detection device 100 of FIG. 1 is not limited to the above-described configuration. The backdoor detection device 100 may be achieved by one physically coupled device, or may be achieved by a plurality of devices by connecting two or more physically separated devices in a wired or wireless manner. For example, the input device 509 and the output device 510 may be connected to the computer device 500 via a network. The backdoor detection device 100 in the first example embodiment illustrated in FIG. 1 may be configured by cloud computing or the like.

In FIG. 1, the pattern extraction unit 101 is means that extracts a function flow pattern from program codes of firmware. The firmware is, for example, software for controlling a device provided from an external business operator. The function flow pattern is a type of function flow executed by firmware. The pattern extraction unit 101 acquires binary codes of the firmware that is a detection target from the device, and acquires program codes by decompiling the acquired codes. At this time, the pattern extraction unit 101 acquires, for example, only a code block including a function depending on an external input (function). The decompiling can be performed by conventional decompiling software or the like.

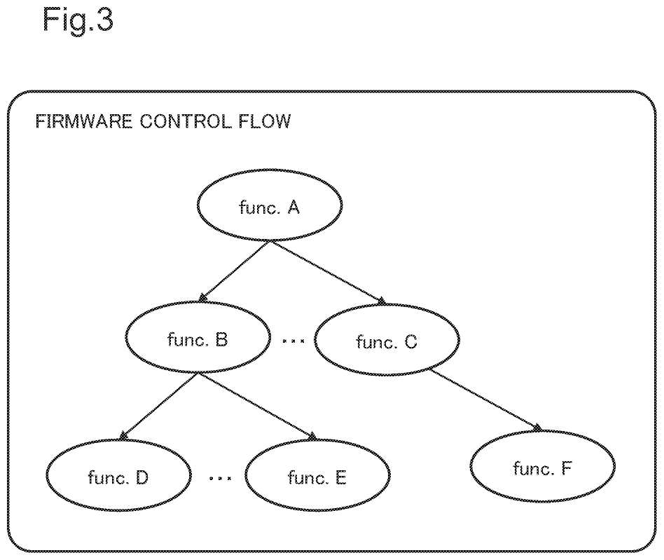

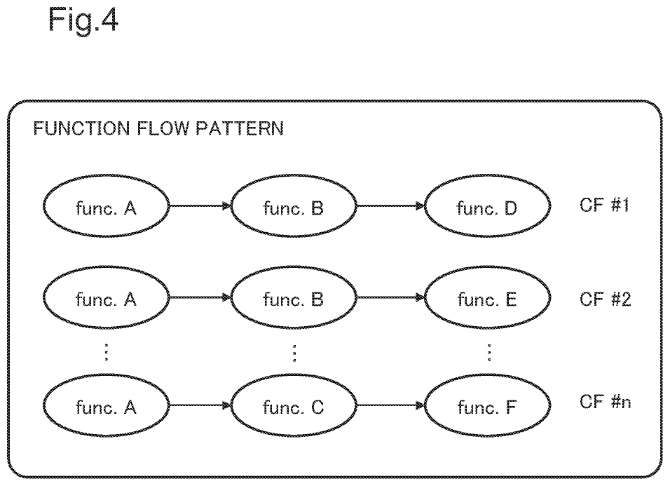

FIG. 3 is a diagram for describing a control flow in the first example embodiment. FIG. 4 is a diagram for describing the function flow pattern in the first example embodiment. As illustrated in FIG. 3, the pattern extraction unit 101 visualizes the control flow indicating an execution path of the program by a known method such as a program analysis tool. Then, as illustrated in FIG. 4, function flow patterns executed in the firmware are extracted from the control flow. In the example of FIG. 4, a function flow pattern CF #1 “func. A→func. B→func. D”, a function flow pattern CF #2 “func. A→func. B→func. E”, and a function flow pattern CF #n “func. A→func. C→func. F” are extracted. The pattern extraction unit 101 outputs the extracted function flow patterns to the frequency information acquisition unit 102.

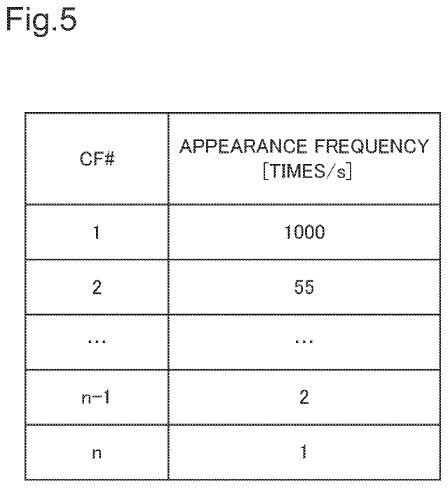

The frequency information acquisition unit 102 is means that acquires appearance frequency information of the function flow pattern extracted by the pattern extraction unit 101. The frequency information acquisition unit 102 acquires the appearance frequency information by, for example, executing the firmware and counting an appearance frequency of the observed function flow pattern. In the present example embodiment, the appearance frequency information of the function flow pattern is indicated by F (CF #) (# is an integer from 1 to n, and n is the number of types of functional flow patterns). FIG. 5 is a table for describing the appearance frequency information in the first example embodiment. In FIG. 5, the appearance frequency of each function flow pattern extracted by the pattern extraction unit 101 is displayed. The frequency information acquisition unit 102 outputs the appearance frequency information of each function flow pattern counted in this manner to the backdoor determination unit 103.

The backdoor determination unit 103 is means that determines whether there is a backdoor based on the appearance frequency information acquired by the frequency information acquisition unit 102. When the appearance frequency information of each function flow pattern is input from the frequency information acquisition unit 102, the backdoor determination unit 103 specifies a function flow pattern having an appearance frequency that is less than a predetermined threshold value. The threshold value is a predetermined number of appearance frequencies, and is, for example, twice per unit time. Information regarding the threshold value is stored in, for example, the storage device 505. In the example of FIG. 5, the backdoor determination unit 103 determines that the frequency of appearance of the function flow pattern CFn is one time, which is less than the threshold value of two times. Thus, the backdoor determination unit 103 specifies the function flow pattern CFn as a function flow pattern including the backdoor. The backdoor determination unit 103 determines that a function flow pattern other than CFn is not the function flow pattern including the backdoor. The backdoor determination unit 103 outputs a determination result obtained by determination in this manner to the output unit 104.

The output unit 104 is means that outputs a result evaluated by the backdoor determination unit 103. When the backdoor determination unit 103 determines that the backdoor is included, the output unit 104 outputs an alert signal. The output unit 104 may display the alert signal by the output device 510 of the backdoor detection device 100 or may present the alert signal by voice. The output unit 104 may output a function flow pattern that is a basis for determining that the backdoor is included, together with the alerts described above.

The operation of the backdoor detection device 100 configured as described above will be described with reference to the flowchart of FIG. 6.

FIG. 6 is a flowchart illustrating an outline of the operation of the backdoor detection device 100 in the first example embodiment. Processes according to this flowchart may be executed based on program control by the processor described above.

As illustrated in FIG. 6, first, the pattern extraction unit 101 extracts a function flow pattern from the program codes of the firmware (Step S101). Then, the frequency information acquisition unit 102 acquires appearance frequency information F (CF #) indicating the appearance frequency of the extracted function flow pattern (Step S102). Then, the backdoor determination unit 103 determines that a backdoor is included if there is a function flow pattern in which the appearance frequency is less than the threshold value in the acquired appearance frequency information (Step S103: YES). On the other hand, if there is no function flow pattern in which the appearance frequency is less than the threshold value in the acquired appearance frequency information, the backdoor determination unit 103 determines that there is no backdoor (Step S103: NO), and a series of flows is repeated. Finally, if the backdoor determination unit 103 determines that the backdoor is included, the output unit 104 outputs an alert signal (Step S104). Thus, the backdoor detection device 100 ends the operation of the backdoor detection.

In the backdoor detection device 100 in the present example embodiment, if there is the functional flow pattern in which the appearance frequency is less than the threshold value in the acquired appearance frequency information, the backdoor determination unit 103 determines that a path has transitioned to a path with a low execution frequency and that the backdoor is included. As a result, it is possible to detect the backdoor without complicated analysis. In the present example embodiment, even when the source codes are unknown at the time of detecting the backdoor, the firmware is decompiled, so that it is possible to detect the backdoor.

### Modification Example of First Example Embodiment

Next, a modification example of the first example embodiment of the present disclosure will be described in detail with reference to the drawings. In the modification example of the first example embodiment of the present disclosure, the frequency information acquisition unit 102 acquires appearance frequency information Fnew (CF #) indicating the appearance frequency of the currently extracted function flow pattern and appearance frequency information Fold (CF #) extracted at a predetermined time point in the past. Then, the backdoor determination unit 103 determines that there is a backdoor when there is a function flow pattern in which the appearance frequency is less than a threshold value (T1) and the appearance frequency of the currently extracted function flow pattern is more than a threshold value (T2) (Fnew−Fold>T2) as compared with the appearance frequency at the predetermined time point in the past among the currently extracted function flow patterns. The currently extracted function flow pattern is a function flow pattern extracted when the firmware is currently verified. The function flow pattern extracted in the past is, for example, a function flow pattern extracted when the same firmware was verified in the past. The appearance frequency information Fold (CF #) of the function flow pattern extracted at the predetermined time point in the past is stored in the storage device 505 at the time of being extracted.

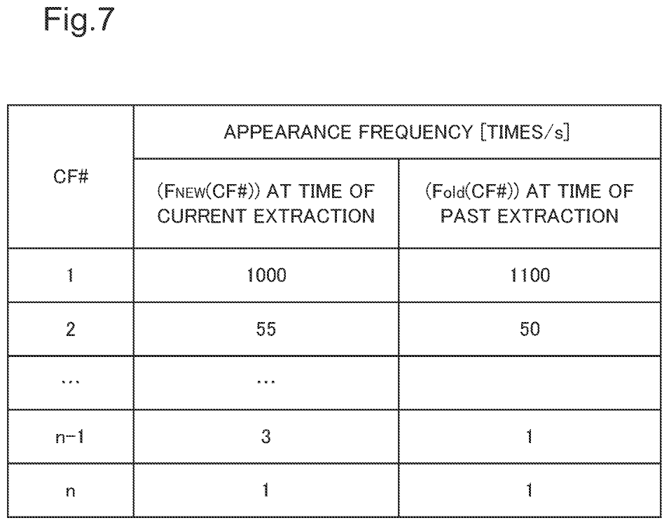

FIG. 7 is a table for describing the appearance frequency information in the modification example of the first example embodiment. As illustrated in FIG. 7, the currently extracted appearance frequency information and the appearance frequency information extracted in the past are illustrated. In the example of FIG. 7, it is assumed that the threshold value T1 is 4 and the threshold value T2 is 1. In the example of FIG. 7, in CFn-1, the appearance frequency at the time of the past extraction is 1, whereas the appearance frequency at the time of the current extraction is 3. On the other hand, in CFn, the appearance frequency at the time of past extraction is 1, whereas the appearance frequency at the time of current extraction is also 1. In any of the function flow patterns, the appearance frequency information Fnew (CF #) is less than the threshold value T1, but only in the CFn-1, the value of Fnew-Fold is more than the threshold value T2. As a result, the backdoor determination unit 103 determines that only CFn-1 includes a backdoor, and does not determine that CFn includes the backdoor.

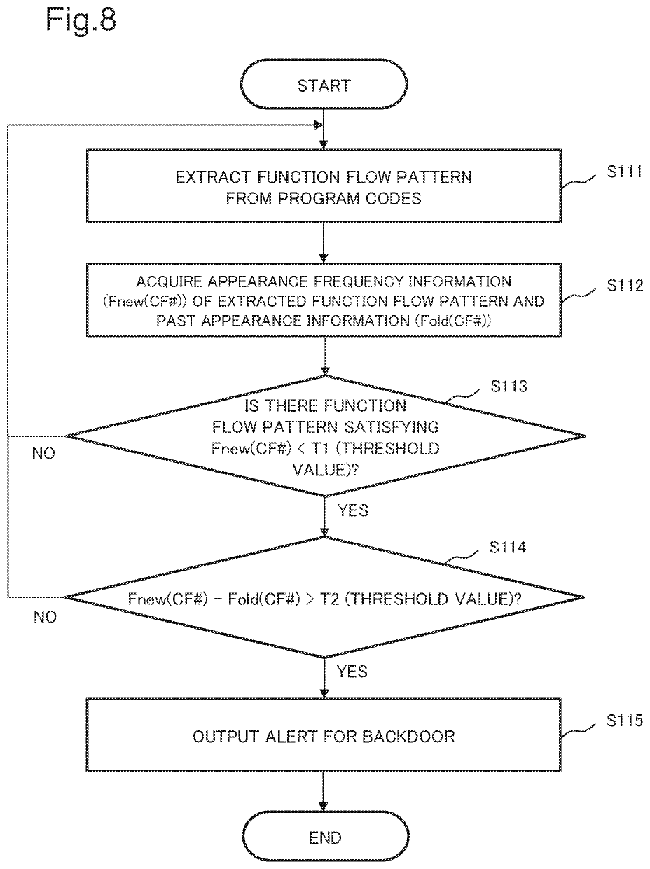

FIG. 8 is a flowchart illustrating an outline of the operation of the backdoor detection device 100 in the modification example of the first example embodiment. Since Steps S111 to S113 in the modification example of the first example embodiment are similar to the flow in Steps S101 to S102 in the first example embodiment, the description thereof will be omitted.

As illustrated in FIG. 8, when the appearance frequency information is input from the frequency information acquisition unit 102, the backdoor determination unit 103 proceeds to the next flow if there is a function flow pattern in which the appearance frequency is less than the threshold value in the appearance frequency information (Step S113; YES). On the other hand, if there is no function flow pattern in which the appearance frequency is less than the threshold value (T1) in the input appearance frequency information, the backdoor determination unit 103 determines that there is no backdoor (Step S113: NO), and a series of flows is repeated. Then, the backdoor determination unit 103 determines that there is the backdoor when the appearance frequency is more than the threshold value (T2) (Fnew−Fold>T2) as compared with the appearance frequency at the predetermined time point in the past for the functional flow pattern in which the appearance frequency is less than the threshold value in Step S113 (Step S114: YES). On the other hand, when the appearance frequency is not more than the threshold value (T2) as compared with the appearance frequency at the predetermined time point in the past for the function flow pattern in which the appearance frequency is less than the threshold value in Step S113, it is determined that there is no backdoor (Step S114; NO), and a series of flows is repeated. Finally, if the backdoor determination unit 103 determines that the backdoor is included, the output unit 104 outputs an alert signal (Step S115). Thus, the backdoor detection device 100 ends the operation of the backdoor detection.

In the backdoor detection device 100 in the present example embodiment, the backdoor determination unit 103 determines that there is a backdoor when there is a function flow pattern in which the appearance frequency is less than a threshold value (T1) and the appearance frequency of the currently extracted function flow pattern is more than a threshold value (T2) (Fnew−Fold>T2) as compared with the appearance frequency at the predetermined time point in the past among the currently extracted function flow patterns. As a result, it is determined that there is the backdoor based on the transition of the appearance frequency information, and thus it is possible to detect the backdoor with higher accuracy.

### Second Example Embodiment

Next, a second example embodiment of the present disclosure will be described in detail with reference to the drawings. Description of contents overlapping with the above description will be omitted in a range in which the description of the present example embodiment is not made unclear. Similarly to the computer device illustrated in FIG. 2, each component in each example embodiment of the present disclosure can be achieved not only by hardware but also by a computer device or firmware based on program control.

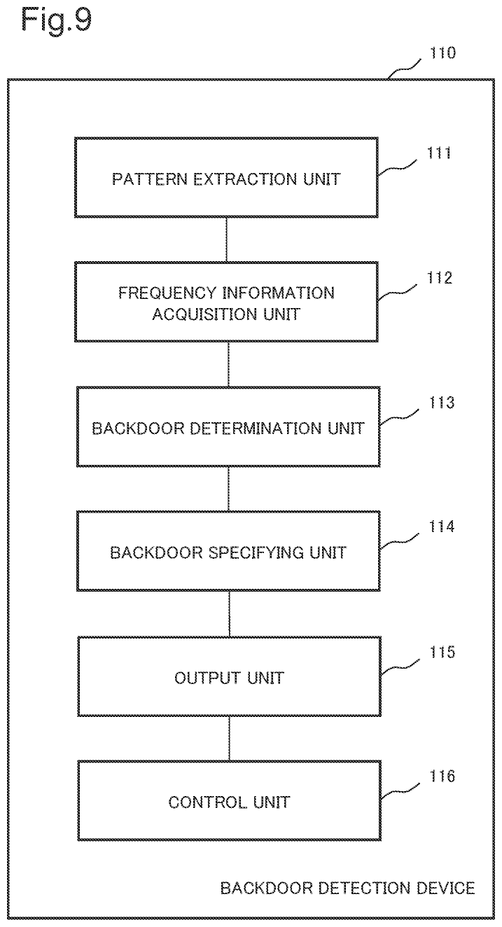

FIG. 9 is a block diagram illustrating a configuration of a backdoor detection device 110 according to the second example embodiment of the present disclosure. Referring to FIG. 9, the backdoor detection device 110 according to the second example embodiment will be described focusing on a part different from the backdoor detection device 100 according to the first example embodiment. The backdoor detection device 110 according to the second example embodiment includes a pattern extraction unit 111, a frequency information acquisition unit 112, a backdoor determination unit 113, a backdoor specifying unit 114, an output unit 115, and a control unit 116. The configurations and functions of the pattern extraction unit 111, the frequency information acquisition unit 112, and the backdoor determination unit 113 in the present example embodiment are similar to those of the pattern extraction unit 101, the frequency information acquisition unit 102, and the backdoor determination unit 103 in the first example embodiment, and thus will be omitted here.

When the backdoor determination unit 113 determines that a backdoor is included, the backdoor specifying unit 114 specifies a function flow determined to include the backdoor. The backdoor specifying unit 114 compares the function flow pattern determined to include the backdoor with the function flow pattern not determined to include the backdoor, and specifies a function flow that does not exist in the function flow pattern not determined to include the backdoor among the function flow patterns determined to include the backdoor.

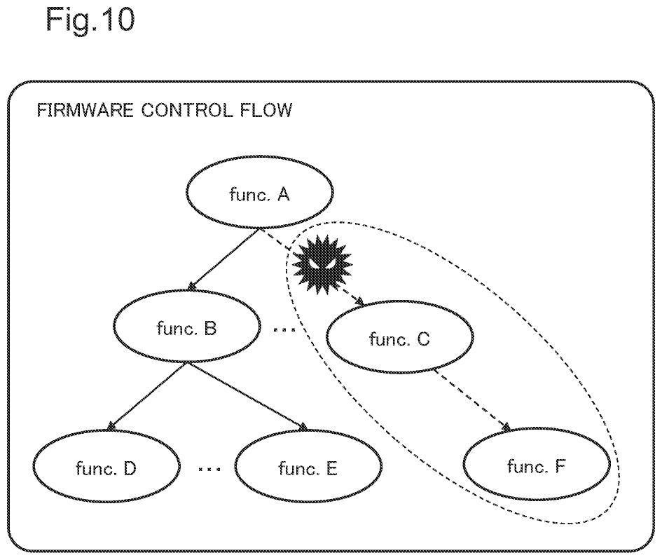

FIG. 10 is a diagram for describing the function flow specified in the second example embodiment.

In FIG. 10, for example, it is assumed that the backdoor determination unit 113 determines that a backdoor is included in a function flow pattern “func. A→func. C→func. F” and does not determine that a backdoor is included in other function flow patterns “func. A→func. B→func. D” and “func. A→func. B→func. E”. In the example of FIG. 10, the function “func. A” is common, but the function flow “func. C→func. F” except for the function “func. A” is different. As a result, the backdoor specifying unit 114 specifies that the backdoor is included in the function flow “func. C→func. F” that does not exist in the function flow pattern not determined to include the backdoor. The backdoor specifying unit 114 outputs information of the specified function flow to the output unit 115 and the control unit 116.

The output unit 115 outputs the function flow specified by the backdoor specifying unit 114 to the output device 510 and the like.

The control unit 116 performs control in such a way as not to execute the function flow specified by the backdoor specifying unit 114. When the information of the function flow specified as the backdoor is input from the backdoor specifying unit 114, the control unit 116 updates the program codes in such a way as not to execute the specified function flow, for example.

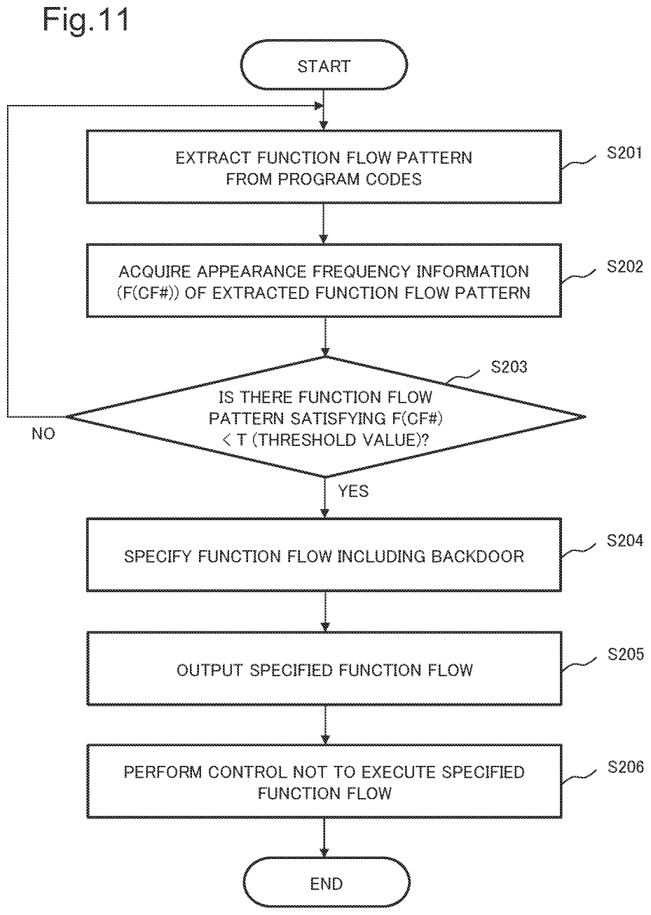

The operation of the information processing system 11 configured as described above will be described with reference to the flowchart of FIG. 11.

FIG. 11 is a flowchart illustrating an outline of the operation of the backdoor detection device 110 in the second example embodiment. Processes according to this flowchart may be executed based on program control by the processor described above. Since Steps S201 to S203 in the second example embodiment are similar to the flow in Steps S101 to S103 in the first example embodiment, the description thereof will be omitted.

As illustrated in FIG. 11, when the backdoor determination unit 113 determines that a backdoor is included (Step S203; YES), the backdoor specifying unit 114 specifies a function flow determined to include the backdoor (Step S204). Then, the output unit 115 outputs information of the specified function flow (Step S205). Finally, the control unit 116 performs control in such a way as not to execute the function flow specified by the backdoor specifying unit 114 (Step S206). Thus, the backdoor detection device 110 ends the operation of the backdoor detection.

In the second example embodiment of the present disclosure, the output unit 115 outputs the information of the function flow specified by the backdoor specifying unit 114 to the output device 510 and the like. As a result, an analyst of the firmware can analyze the location where the backdoor is incorporated in more detail. In the second example embodiment of the present disclosure, the control unit 116 performs control in such a way as not to execute the function flow specified by the backdoor specifying unit 114. As a result, it is possible to prevent spreading of a damage caused by the backdoor.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, although a plurality of operations are described in order in the form of the flowchart, the order of description does not limit the order of executing the plurality of operations. Therefore, when each example embodiment is implemented, the order of the plurality of operations can be changed within a range that does not interfere in content.

The threshold value T1 and the threshold value T2 illustrated in the present example embodiment are examples, and the threshold values may be changed according to the type of the assembled backdoor. As a result, it is possible to enhance the accuracy of detection of the backdoor.
5 Reference Signs List
100, 110 backdoor detection device
101, 111 pattern extraction unit
102, 112 frequency information acquisition unit
10 103, 113 backdoor determination unit
104, 115 output unit
114 backdoor specifying unit
116 control unit

What is claimed is:

1. A backdoor detection device comprising:
a memory storing instructions; and
at least one processor configured to execute the instructions to:
extract a function flow pattern from program codes of firmware;
acquire appearance frequency information indicating an appearance frequency of the extracted function flow pattern;
determine whether a backdoor is included based on the acquired appearance frequency information; and
output information indicating a result of the determination.

2. The backdoor detection device according to claim 1, wherein the at least one processor is further configured to execute the instructions to:
extract the function flow pattern from program codes obtained by decompiling binary codes.

3. The backdoor detection device according to claim 1, wherein the at least one processor is further configured to execute the instructions to:
determine that the backdoor is included when there is a function flow pattern in which the appearance frequency is less than a predetermined threshold value among the extracted function flow patterns.

4. The backdoor detection device according to claim 1, wherein the at least one processor is further configured to execute the instructions to:
acquire appearance frequency information at a predetermined time point in past, and
determine that there is a backdoor when there is a function flow pattern in which the appearance frequency is less than a threshold value and the appearance frequency is more than the threshold value as compared with the appearance frequency at a predetermined time point in the past among the extracted function flow patterns.

5. The backdoor detection device according to claim 1, wherein the at least one processor is further configured to execute the instructions to:
specify a function flow determined to include the backdoor, and
output information of the function flow determined to include the backdoor.

6. The backdoor detection device according to claim 5, wherein the at least one processor is further configured to execute the instructions to:
perform control in such a way as not to execute the specified function flow.

7. A backdoor detection method comprising:
extracting a function flow pattern from program codes of firmware;
acquiring appearance frequency information indicating an appearance frequency of the extracted function flow pattern;
determining whether a backdoor is included based on the acquired appearance frequency information; and
outputting information indicating a result of the determination.

8. A non-transitory computer readable recording medium storing a program for causing a computer to perform:
extracting a function flow pattern from program codes of firmware;
acquiring appearance frequency information indicating an appearance frequency of the extracted function flow pattern;
determining whether a backdoor is included based on the acquired appearance frequency information; and
outputting information indicating a result of the determination.
